(19) United States
(12) Patent Application Publication
(10) Pub. No.: US 2026/0091701 A1
(43) Pub. Date: Apr. 2, 2026

(54) METHOD AND DEVICE FOR INTERRUPTING A CHARGING PROCESS OF A POWER SOURCE OF AN ELECTRIC DRIVE

(71) Applicant: Robert Bosch GmbH, Stuttgart (DE)

(72) Inventors: Seifeldin Tarek Mohamed Shaaban, Stuttgart (DE); Jihane Ramzi, Stuttgart (DE)

(21) Appl. No.: 19/110,748

(22) PCT Filed: Jul. 12, 2023
(86) PCT No.: PCT/EP2023/069290

§ 371 Date: Mar. 11, 2025

(30) Foreign Application Priority Data
Sep. 29, 2022 (DE) 10 2022 210 343.2

(51) Int. Cl. B60L 53/62; B60L 15/00; B60L 53/20

(52) U.S. Cl. CPC B60L 53/62; B60L 15/007; B60L 53/20

(57) ABSTRACT

The present invention relates to a method (500) for interrupting a charging process of a power source (230) of an electric drive (200), having the steps of: detecting (510) a fault at a highside switch (231, 233, 235) of a first half-bridge of the inverter (210); and closing (520) a lowside switch (232, 234, 236) of a half-bridge of the inverter (210).

### BACKGROUND

The present invention relates to a method and device for interrupting a charging process of a power source of an electric drive, a power train having the device, a vehicle having a power train, and a computer program and computer-readable storage medium.

E-mobility is an important part of our efforts to develop more environmentally-friendly methods of travel. However, in order to achieve widespread acceptance of electric vehicles, several prerequisites must be met. In addition to a sufficient vehicle range, power sources must be ubiquitously available to ensure that electric vehicles can be charged at all times. Further, the required charging time must be kept low in order to avoid long delays.

When the electric vehicle is charged at an alternating voltage (AC) charging station, such as when connected to the public power grid, the alternating voltage is converted by a rectifier, preferably an internal rectifier within the vehicle, to a DC voltage (DC). Fast charging stations that provide direct DC voltage and are characterized by a lower charging time are increasingly common. An exemplary DC fast charging station is known from WO 2012/038222 A3. An inverter for converting electrical energy of a DC voltage source into alternating voltage to drive an electric machine is known from WO 2019/215128 A1. This inverter is further configured to raise a charging voltage of a charging device to a higher voltage. Such boosters are used if the available charging voltage is less than the voltage required to charge a vehicle battery. Corresponding inverters include switches or relays that, when closed, allow a charging process and thus power flow from the charging device through a winding of the electric machine via the inverter actuated as a boost converter into a connected battery. During the charging process, faults may occur that need to be rectified. A fault that is critical to the system is the failure, or permanently closed state, of an upper circuit breaker of a half-bridge of the inverter. The higher voltage of the vehicle battery to be charged is then permanently abutted on the charger, which, however, is only configured for a lower charging voltage. This may lead to the destruction of the charging station. Therefore, there is a need for solutions to detect such faults and minimize the resulting damage. For this purpose, solutions are required that function safely, reliably and quickly at the high electrical voltages and currents occurring in the process.

### SUMMARY

The present invention creates a method, a device, a power train, a vehicle, a computer program, and a computer-readable storage medium with the features of the disclosure.

Accordingly, the invention relates to a method for interrupting a charging process of a power source of an electric drive. Preferably, the invention relates to a method for interrupting a charging process of a power source for or with an electric drive.

The electric drive is preferably configured to operate a vehicle. The electric drive includes an inverter and a multi-phase electric machine, wherein the inverter has a positive input terminal on the input side and a negative input terminal for connecting a power source, preferably a DC power source, for example a battery or a traction battery or a fuel cell. A fuse is arranged between the positive terminal of the power source and the positive input terminal of the inverter. Preferably, such a fuse is integrated into a common housing with the power source.

Preferably, the fuse is embodied as a mechanical fuse, an electronic fuse, a hybrid fuse, a protective fuse, a pyro fuse, and a semiconductor switch, preferably bi-directional. Preferably, systems of battery-electric vehicles are provided such fuses within the housing of the battery or power source in battery management systems. Power sources for battery-electric vehicles preferably include corresponding fuses to prevent a short-circuit of the two poles of the power source or the power source terminal pins. Advantageously, corresponding fuses open in a very short time when the short-circuit current becomes very large within a short time. On the output side, the inverter comprises a multi-phase connection for connecting phase terminals of the multi-phase electric machine. The inverter is configured to provide electrical power to the electric machine in motor operation and to receive electrical power of the electric machine in generator operation. The inverter comprises a plurality of circuit breakers. The circuit breakers are arranged in half-bridges connected in parallel as highside switches and lowside switches, and the half-bridges are connected between the positive input terminal and the negative input terminal of the inverter. A center tap of a half-bridge between the respective highside switch and lowside switch is connected to a phase of the multi-phase terminal. The inverter's highside switches and lowside switches are modulated, preferably pulse width modulated or block commutated, in motor or generator operation. The power received in the generator operation is preferably passed to the connected power source for charging the power source. The multi-phase electric machine comprises a plurality of windings, preferably at least one per phase. Preferably, each of the phases comprises a phase terminal connected to the multi-phase terminal of the inverter for connection to the inverter. At least one winding of the multi-phase electric machine comprises a further winding terminal. The winding terminal is connected to a motor terminal.

Preferably, a winding terminal is configured as one of the two terminal contacts at the ends of a winding. Preferably, a winding connection can also be formed between the two ends of a winding. Preferably, a winding terminal is consequently connected to a phase terminal of the electric machine or is arranged between at least two of the windings of the multi-phase machine or is arranged within a winding of the windings of the multi-phase machine. The winding terminal of the electric machine is connected to a motor terminal. Preferably, the motor terminal is a contact connected to the winding terminal. The motor terminal is connected to a positive charging terminal. The negative input terminal is connected to a negative charging terminal.

Preferably, the electric drive comprises a switch connected between the motor terminal and the positive charging terminal. Preferably, the switch is closed during the charging process and open during driving operation of the vehicle (motor operation, generator operation). The switch is preferably configured as an electromechanical switch, i.e. as a contactor or as a relay. Preferably, the electric drive comprises a first capacitor connected in parallel to the positive charging terminal and the negative charging terminal, at least during the charging process. Preferably, the first capacitor attenuates the voltage and current fluctuations arising during the switching processes of the inverter's circuit breakers at the positive and negative charging terminal. During the charging process of the power source, a charging power source is connected to the positive charging terminal and the negative charging terminal. In so doing, electrical energy from the charging power source is provided via the inverter for charging the power source. Preferably, the charging power source is a charging station or charging column, preferably in the infrastructure, which provides electrical power for charging power sources of vehicles. Preferably, electrical energy is provided by means of the charging power source for charging a power source connected to the input terminal. Preferably, when the power source is charged, a charging current from the charging source flows through the positive charging terminal via the motor terminal through at least one winding of the electric machine and through at least one of the high-side switches of the inverter via the positive input terminal into the power source.

Connecting and disconnecting or decoupling, or respectively, connected and disconnected are used as equivalent to galvanically connected and galvanically isolated.

Preferably, the windings of the multi-phase electric machine are connected in a star circuit. The star point of the electric machine is configured as a winding terminal. Preferably, the electric drive comprises an inverter and an electric machine whose windings are connected in a star circuit, wherein the star point of the electric machine is configured as a winding terminal.

The winding terminal is connected to the motor terminal. Preferably, an electric circuit is provided that enables a switchable charging terminal for connecting and disconnecting a charging power source to an electric drive via the star point of the electric machine.

The method comprises the steps of: detecting a fault on a highside switch of a first half-bridge of the inverter and closing a lowside switch of a half-bridge, in particular the lowside switch of the first half-bridge, of the inverter. This sequence of steps first determines that there is a fault. Preferably, a fault is detected if a high-side is closed and can no longer be opened. In particular, a signal to open the switch is present at the control input of the highside switch and the switch remains closed. In this fault case, a high current flows through the switch and a minimum voltage drops across the switch. If this state were maintained, the direction of current would rotate from the charging power source to the power source during the charging process. This would result in an unrestrained current flowing from the power source towards the charging power source. However, the charging power source and internal or connected components, such as DC link capacitors, are not configured for the high voltage of the power source. This would lead to destruction of the charging power source and other components. Thus, the second step is implemented, preferably immediately and or permanently, to prevent destruction of the charging power source. A lowside switch of a half-bridge, preferably the lowside switch of the first half-bridge, is closed. This results in an immediate short-circuit of the power source via the two power switches of the inverter including at least one winding of the electric machine, preferably a short-circuit of the power source via the two power switches of a first half-bridge of the inverter. Alternatively, two of the lowside switches may also be closed, preferably those of a second and third half-bridge. The rapidly forming high current also flows through the fuse. The fastest current increase, and thus the fastest trip of the fuse, occurs when the short-circuit occurs only via the two circuit breakers of a first half-bridge of the inverter. Reliable, safe and very quickly, the fuse opens the circuit and eliminates the immediate risk of destroying the load power source.

Advantageously, a method for the electric drive is provided that prevents destruction of the charging power source during a charging process of the power source. No additional circuitry is required for this purpose. If the fuse is a non-reversible fuse, it should preferably be replaced in a workshop. Preferably, the fault on the highside switch in the inverter would also be rectified. Preferably, the total damage to be repaired is significantly less than the potential damage to the charging power source.

In one embodiment, the fault is detected on the highside switch by means of an overcurrent protection circuit, diagnostic methods and/or at least one phase current sensor of the inverter.

To perform the method, circuit components are used that are also used for the regular operation of the electric drive. The fault on the highside switch of a first half-bridge of the inverter is preferably detected by means of an existing overcurrent protection circuit. This circuit is used for the driving operation of the inverter or electric drive in order to detect high loads of a circuit breaker in the inverter and to avoid too high loads using suitable operating strategies. Alternatively or additionally, further diagnostic methods are used for detection, which are preferably also used during the driving operation of the electric drive. Alternatively or additionally, measured values of at least one phase current sensor are taken into account to detect the error.

Advantageously, a method for detecting the fault on a highside switch for use during the charging process is provided.

Furthermore, the invention comprises a device for interrupting a charging process of a power source of an electric drive. The device is further configured to perform the method described. Preferably, the device comprises a control unit, preferably with a microcontroller, a power supply, at least one signal input, preferably for detecting a fault, and or at least one signal output, preferably for closing the lowside switch. Advantageously, a device is provided that is configured to prevent destruction of a charging power source during a charging process.

Furthermore, the invention relates to a power train having the device described, wherein the power train comprises the, preferably multi-phase, inverter, electric machine and/or power source. Advantageously, a power train is provided with a device configured to prevent destruction of a charging power source during a charging process. This allows for safe operation of the powertrain.

The invention also relates to a vehicle with the power train. Advantageously, a vehicle with a device is provided that is configured to prevent destruction of a charging power source during a charging process. This allows for safe operation of the vehicle.

The invention further relates to a computer program comprising commands which, when the program is executed by a device, prompt the latter to perform the steps of the method described.

The invention further relates to a computer-readable storage medium comprising commands which, when executed by a device, cause the device to perform the method steps.

### BRIEF DESCRIPTION OF THE DRAWINGS

Shown are:

FIG. 1 a first schematic block diagram of an electric drive having a device;

FIG. 2 a schematic view of a vehicle with an electric power train with a device;

FIG. 3 a schematic flow diagram illustrating a method of interrupting a charging process of a power source of an electric drive.

In the figures, identical elements or elements with the same function are provided with the same reference signs.

### DETAILED DESCRIPTION

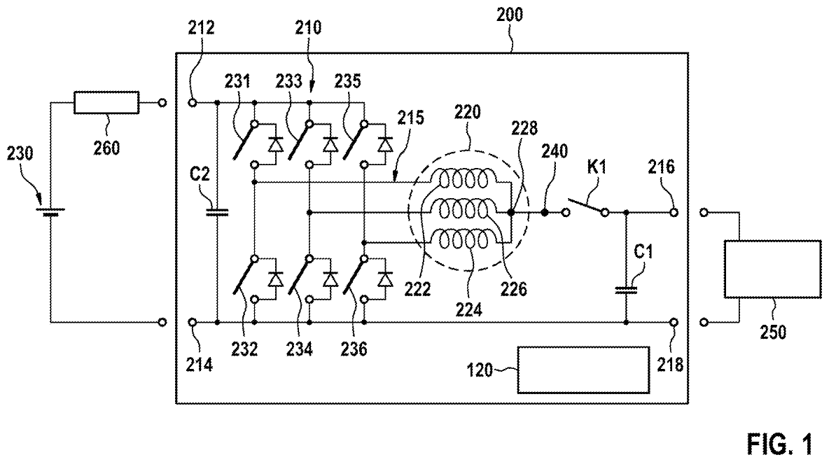

FIG. 1 shows a schematic block diagram of an electric drive 200. The electric drive 200 is preferably configured to operate a vehicle 400. The electric drive 200 comprises an inverter 210 and a multi-phase electric machine 220. The inverter 210 comprises a positive input terminal 212 on the input side and a negative input terminal 214 for connecting a power source 230. A fuse 260 is arranged between the positive terminal of the power source 230 and the positive input terminal 212 of the inverter. The fuse 260 is configured to rapidly cut a current flow out of the battery or into the battery if it exceeds a pre-determinable threshold value. Preferably, the inverter 210 comprises a second capacitor C2, preferably a DC link capacitor. On the output side, the inverter 210 comprises a multi-phase connector 215 for connecting the multi-phase electric machine 220, preferably for connection to the phase terminals of the individual phases, or windings, of the electric machine 220. The inverter 210 is configured to provide electrical power to the electric machine 220 in motor operation and to receive electrical power of the electric machine 220 in generator operation. The inverter comprises a plurality of circuit breakers. The circuit breakers 231. 236 are arranged in half-bridges connected in parallel as highside switches and lowside switches, and the half-bridges are connected between the positive input terminal 212 and the negative input terminal 214 of the inverter. A center tap of a half-bridge between the respective highside switch and lowside switch is connected to a phase of the multi-phase terminal 215. The windings 222, 224, 226 of the multi-phase electric machine 220 are connected in a star circuit. A delta connection of the windings is also possible. One winding terminal 228, preferably a contacting on a winding, of the electric machine 220 is preferably connected to a motor terminal 240. Preferably, the winding terminal corresponds to a phase terminal of the electric machine. However, contacting at another location of the winding is also possible as a winding terminal, preferably within the winding or at the other end of the winding, between the plurality of windings of the electric machine. The winding terminal 228 shown corresponds to the star point of the windings of the electric machine connected in a star circuit. The star point is configured as the winding terminal 228. Advantageously, the current flow of a charging current is selectively routed via one or more windings and switches of the inverter by means of appropriate actuation of the highside switches and or lowside switches of the half-bridges of the inverter. As a result, a more even load may be achieved on the windings and circuit breakers (231. 236) of the inverter 210. The motor terminal 240 is connected to a positive charging terminal 216 and the negative input terminal 214 is connected to a negative charging terminal 218. During the charging process of the power source 230, a charging power source 250 is connected to the positive charging terminal 216 and the negative charging terminal 218. In so doing, electrical energy from the charging power source 250 is provided via the windings of the electric machine and the inverter 210 for charging the power source 230. Preferably, the positive and negative charging terminal 216, 218 is configured to be connected to a charging power source 250 for charging operation for charging the power source 230. The device 120 is configured to close, preferably permanently, a lowside switch 232, 234, 236 of a half-bridge of the inverter 210, preferably the lowside switch 232, 234, 236 of the first half-bridge of the inverter 210, depending on detecting 510 a fault at a highside switch 231, 233, 235 of a first half-bridge of the inverter 210. Preferably, the device 120 comprises a control unit, preferably with a microcontroller, a memory, a control circuit, a power supply, signal inputs and/or signal outputs for detecting a fault and closing the lowside switch. Correspondingly, preferred electrical, optical, or wireless connections between the device 120 and the circuit breakers 231. 236 are not shown to maintain the clarity of FIG. 1. Preferably, the device 120 is arranged with the inverter 210 and/or the electric machine 220 inside a common housing. Alternatively, the device 120 may be arranged in a separate housing and connected by means of lines to the respective terminals and connections to the electric machine 220, the inverter 210 and/or input terminal 212, 214 and the positive charging terminal 216, 218. Preferably, the electric drive 200 comprises a switch Kl connected between the motor terminal 240 and the positive charging terminal 216. Preferably, the switch KI is closed during the charging process and open during driving operation of the vehicle (motor operation, generator operation). The switch Kl is preferably configured as an electromechanical switch, i.e. as a contactor or as a relay.

Preferably, the electric engine 200 comprises a first capacitor C1 connected in parallel to the positive charging terminal 216 and the negative charging terminal 218, at least during the charging process. Preferably, the first capacitor C1 attenuates the voltage and current fluctuations arising during the switching processes of the inverter's circuit breakers 231. 236 at the positive and negative charging terminal 216, 218.

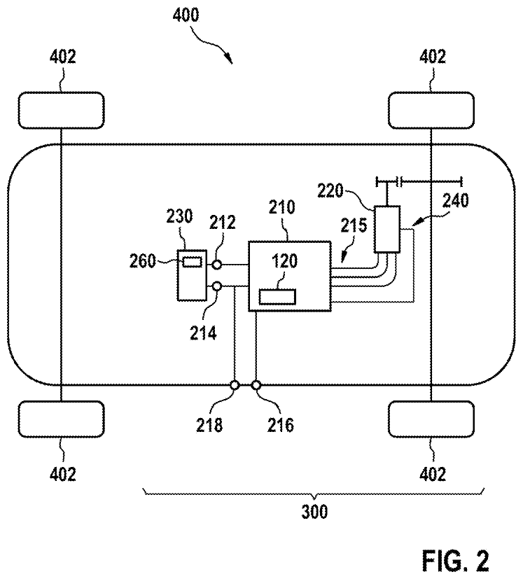

FIG. 2 shows a schematic illustration of a vehicle 400 having an electric power train 300 and device 120. The vehicle 400 preferably comprises four wheels 402 that are preferably driven by the electric machine 220. This illustration shows only one possible embodiment of a vehicle 400. Preferably, the vehicle is any vehicle for use in the water, on land, or in the air. The power train 300 comprises the device 120, the inverter 210, the, preferably multi-phase, electric machine 220 and/or the power source 230. In the illustration, the fuse 260 is, by way of example, integrated in the housing of the power source 230. Preferably, the electrical power source 230 is connected to the inverter 210 via the input terminals 212, 214. The charging terminals 218, 216 are configured to be connected to a charging power source 250 (not shown) during the charging process for charging the power source 230.

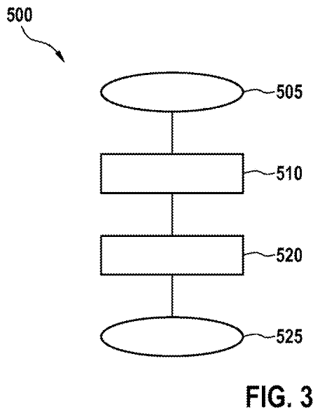

FIG. 3 shows a schematic flow diagram illustrating a method 500 for interrupting a charging process of a power source 230 of an electric drive 200. The method 500 starts with step 505. In step 510, a fault is detected on a highside switch 231, 233, 235 of a first half-bridge of the inverter 210. In step 520, a lowside switch 232, 234, 236 of a half-bridge of the inverter, preferably the lowside switch 232, 234, 236 of the first half-bridge of the inverter, is closed. The method 500 ends at step 525.

1. A method (500) for interrupting a charging process of a power source (230) of an electric drive (200),
wherein the electric drive (200) comprises an inverter (210) and a multi-phase electric machine (220), wherein the inverter (210) on the input side comprises a positive input terminal (212) and a negative input terminal (214) for connecting the power source (230),
wherein a fuse (260) is arranged between the positive terminal of the power source (230) and the positive input terminal (212) of the inverter, wherein the inverter comprises a multi-phase terminal (215) on the output side for connecting the multi-phase electric machine (220), wherein the inverter (210) comprises a plurality of circuit breakers (231. 236), wherein the circuit breakers (231. 236) are arranged in half-bridges connected in parallel as highside switches and lowside switches, and the half-bridges are connected between the positive input terminal (212) and the negative input terminal (214) of the inverter, wherein a center tap of a half-bridge is connected between the respective highside switch and lowside switch to a phase of the multi-phase terminal (215), wherein the inverter is configured to supply the electric machine (220) with electrical power in a motor operation and to receive electrical power of the electric machine (220) in a generator operation, wherein at least one of the windings of the multi-phase electric machine (220) comprises a winding terminal (228) and the winding terminal (228) of the electric machine (220) is connected to a motor terminal (240),
wherein the motor terminal (240) is connected to a positive charging terminal (216), and the negative input terminal (214) is connected to a negative charging terminal (218),
wherein during the charging process of the power source (230), a charging power source (250) is connected to the positive charging terminal (216) and the negative charging terminal (218), and provides electrical power via the inverter (210) for charging the power source (230),
said method comprising the following steps:
detecting (510) a fault on a highside switch (231, 233, 235) of a first half-bridge of the inverter (210); and
closing (520) a lowside switch (232, 234, 236) of a half-bridge of the inverter (210).

2. The method according to claim 1,
wherein detecting the fault on the highside switch is performed by means of an overcurrent protection circuit, diagnostic methods, and/or at least one phase current sensor of the inverter (210).

3. A device (120) for interrupting a charging process of a power source (230) of an electric drive (200),
wherein the electric drive (200) comprises an inverter (210) and a multi-phase electric machine (220), wherein the inverter (210) on the input side comprises a positive input terminal (212) and a negative input terminal (214) for connecting the power source (230), wherein a fuse (260) is arranged between the positive terminal of the power source (230) and the positive input terminal (212) of the inverter,
wherein the inverter comprises a multi-phase terminal (215) on the output side for connecting the multi-phase electric machine (220), wherein the inverter (210) comprises a plurality of circuit breakers (231. 236),
wherein the circuit breakers (231. 236) are arranged in half-bridges connected in parallel as highside switches and lowside switches, and the half-bridges are connected between the positive input terminal (212) and the negative input terminal (214) of the inverter, wherein a center tap of a half-bridge is connected between the respective highside switch and lowside switch to a phase of the multi-phase terminal (215), wherein the inverter is configured to supply the electric machine (220) with electrical power in a motor operation and to receive electrical power of the electric machine (220) in a generator operation,
wherein at least one of the windings of the multi-phase electric machine (220) comprises a winding terminal (228) and the winding terminal (228) of the electric machine (220) is connected to a motor terminal (240),
wherein the motor terminal (240) is connected to a positive charging terminal (216), and the negative input terminal (214) is connected to a negative charging terminal (218),
wherein during the charging process of the power source (230), a charging power source (250) is connected to the positive charging terminal (216) and the negative charging terminal (218), and provides electrical power via the inverter (210) of the power source

(230)
wherein the device (120) is configured to control a method according to claim 1.

4. A power train (300) having a device (120) according to claim 3, wherein the power train (300) comprises the inverter (210), the electric machine (220), and/or the power source (230).

5. A vehicle (400) having a power train (300) according to claim 4.

6. (canceled)

7. A non-transitory, computer-readable storage medium comprising instructions which, when executed by a computer cause the computer to control a power source (230) of an electric drive (200),
wherein the electric drive (200) comprises an inverter (210) and a multi-phase electric machine (220), wherein the inverter (210) on the input side comprises a positive input terminal (212) and a negative input terminal (214) for connecting the power source (230),
wherein a fuse (260) is arranged between the positive terminal of the power source (230) and the positive input terminal (212) of the inverter, wherein the inverter comprises a multi-phase terminal (215) on the output side for connecting the multi-phase electric machine (220), wherein the inverter (210) comprises a plurality of circuit breakers (231. 236), wherein the circuit breakers (231. 236) are arranged in half-bridges connected in parallel as highside switches and lowside switches, and the half-bridges are connected between the positive input terminal (212) and the negative input terminal (214) of the inverter, wherein a center tap of a half-bridge is connected between the respective highside switch and lowside switch to a phase of the multi-phase terminal (215), wherein the inverter is configured to supply the electric machine (220) with electrical power in a motor operation and to receive electrical power of the electric machine (220) in a generator operation, wherein at least one of the windings of the multi-phase electric machine (220) comprises a winding terminal (228) and the winding terminal (228) of the electric machine (220) is connected to a motor terminal (240),
wherein the motor terminal (240) is connected to a positive charging terminal (216), and the negative input terminal (214) is connected to a negative charging terminal (218),
wherein during the charging process of the power source (230), a charging power source (250) is connected to the positive charging terminal (216) and the negative charging terminal (218), and provides electrical power via the inverter (210) for charging the power source (230),
by:
detecting (510) a fault on a highside switch (231, 233, 235) of a first half-bridge of the inverter (210); and
closing (520) a lowside switch (232, 234, 236) of a half-bridge of the inverter (210).
